(19) United States
(12) Patent Application Publication
(10) Pub. No.: US 2023/0321671 A1
(43) Pub. Date: Oct. 12, 2023

(54) SYSTEMS AND METHODS FOR MOTOR SOURCE DRIVEN BIOLOGICAL SAMPLE PROCESSING

(71) Applicant: ARTHREX, INC., Naples, FL (US)

(72) Inventors: Christopher BARE, Naples, FL (US); Ricardo ALBERTORIO, Naples, FL (US); Robert HARRISON, Naples, FL (US)

(73) Assignee: ARTHREX, INC., Naples, FL (US)

(21) Appl. No.: 18/125,461

(22) Filed: Mar. 23, 2023

Related U.S. Application Data
(60) Provisional application No. 63/362,685, filed on Apr. 8, 2022.

(51) Int. Cl. B04B 5/04; B01L 3/00; B04B 3/00; B04B 9/02

(52) U.S. Cl. CPC B04B 5/0414; B01L 3/50215; B04B 3/00; B04B 9/02; B01L 2300/0681; B01L 2400/0409

(57) ABSTRACT

Provided herein are systems and methods for biological sample concentration, purification, and fractionation of biological samples. The systems can comprise one or more containment devices for a biological sample connected to a shaft; a handheld motor source connected to the shaft and configured to modulate spinning the one or more containment devices along an axis of the one or more containment devices.

### PRIORITY

This application claims the benefit of U.S. Ser. No. 63/362,685, filed on Apr. 8, 2022, which is incorporated by reference herein in its entirety.

### BACKGROUND

Therapeutic fluid and compositions with enhanced concentrations of therapeutically active factors can be used in the treatment of mammalian injuries or diseases, but often must be processed in a centrifuge. Devices and methods for extracting, separating, and concentrating fractionated biological fluids or tissues in surgical arenas without the use of a traditional centrifuge are needed in the art.

### SUMMARY OF THE DISCLOSURE

Therapeutic factors, including growth factors, cytokines, and certain proteins, and plasma, and viable cells that can produce therapeutic factors are useful for treating damaged tissue. Therapeutic factors can be found in biologic fluids, cells, and tissues. These therapeutic factors can be separated or concentrated by benchtop or standalone centrifuges, but not all surgical sites have access to centrifuges. Therefore, provided herein are improved devices and methods for quickly and simply extracting and concentrating therapeutically active factors from mammalian tissues, cells and biological fluids.

In one aspect, a system for biological sample processing is provided. The system comprises one or more containment devices for a biological sample connected to a shaft and a handheld motor source connected to the shaft and configured to modulate spinning the one or more containment devices along an axis (e.g., a longitudinal axis, lateral axis, or vertical axis) of the one or more containment devices. The one or more containment devices can comprise two or more tubular vessels counter disposed within buckets, wherein the two or more tubular vessels are configured to freely rotate from an upright position to a horizontal position or any angle between the upright position and the horizontal position. The one or more containment devices can comprise one or more inlet or outlet ports. The one or more containment devices can comprise a disc having a top plate, a bottom plate, and an outside wall, wherein the top plate, bottom plate, and outside wall all have an inner surface and an outer surface; the outside wall connects the top and bottom plates; and the inner surface of the top plate and the inner surface of the bottom plate face one other; and a compartment enclosed by the inner surfaces of the top plate, bottom plate, and outside wall. The one or more containment devices can further comprise at least one filter element or membrane comprising an inside edge and an outside edge, wherein the at least one filter element or membrane is located inside the compartment. The containment device can comprise a variable volume separation chamber, a disc shaped top support plate, and a disc shaped bottom support plate. The containment device can comprise a variable volume separation chamber and a disc shaped bottom support plate. A distal portion of the shaft and the one or more containment devices can be housed within an enclosure. The system can be handheld and can be operated under the full control of a user. The handheld motor source can spin the one or more containment devices at a rate of rotations per minute sufficient produce g-forces needed for separating biological samples. The handheld motor source can be configured to adjust a first g-force to a second g-force within about 0.5, 1, 2, 3, 4, 5, 6, 7, 8, 9, 10, 11, 12, 13, 14, 15, 16, 17, 18, 19, 20, 30, 40, 50, 60, or 70 seconds without causing rotations per minute of the motor source to reach zero. The handheld motor source can comprise a surgical drill, a dental handpiece, a surgical shaver, or a handheld device capable of reaching a rate of rotations per minute sufficient for concentration, purification, or fractionation of a biologic sample. The one or more containment devices of the system can be disposable. A fraction of the biological sample can be extracted from the one or more containment devices using one or more outlet ports. The system can further comprise a base configured to accept a distal end of the shaft for stabilization. The containment device can be removable from the shaft and the handheld motor source is removable from the shaft.

In another aspect, a method of processing a biological sample is provided. The method can comprise placing a biological sample within one or more containment devices of the systems described herein and activating the handheld motor source to spin the shaft and the one or more containment devices; allowing the biological sample to spin at one or more rate(s) of rotations per minute for a set period of time; and obtaining a processed biological sample. The biological sample can be spun at a first rate of rotations per minute and then at a second rate of rotations per minute. The biological sample can be spun at a first rate of rotations per minute and then at a second rate of rotations per minute without stopping the motor source. The method of processing can further comprise concentrating the biological sample, purifying the biological sample, fractionating the biological sample, extracting the biological sample, filtering the biological sample, enriching the biological sample, or combinations thereof. A distal end of the shaft can be placed in a base to stabilize the system. At least a distal portion of the shaft and the containment device can be present within an enclosure.

Yet another aspect provides a method of preparing platelet rich plasma using the systems described herein. The method can comprising placing a whole blood sample into one or more containment devices of a system described herein; attaching a handheld motor to a proximal region of a shaft; attaching one or more containment devices to a distal region of a shaft; actuating the handheld motor to spin the one or more containment devices causing the whole blood sample to fractionate into a platelet poor plasma layer, a buffy layer, and an erythrocyte layer within the one or more containment devices; removing at least a portion of the platelet poor plasma layer from the one or more containment devices; and actuating the handheld motor to spin the containment device causing any of the platelet poor plasma layer, the buffy layer, and the erythrocyte layer to fractionate into a platelet rich plasma layer and an erythrocyte layer.

Another aspect provides a method for purifying a biological sample using the systems described herein. The method can comprise a) placing a biological sample within one or more containment devices of a system described herein; b) activating the handheld motor source to spin the shaft and the one or more containment devices; c) allowing the biological sample to spin at one or more rate(s) of rotations per minute for a set period of time; and d) removing a portion of the biological sample. The biological sample can be spun at a first rate of rotations per minute and then at a second rate of rotations per minute. The biological sample can be spun at a first rate of rotations per minute and then at a second rate of rotations per minute without stopping the motor source. The method can further comprise repeating steps b)-d) 1, 2, 3, 4, 5, 6, 7, 8, 9, or 10 times. The method can further comprise discarding the removed portion of the biological sample and/or increasing one or more components of the biological sample in the sample, thereby concentrating the biological sample. The method can further comprise adding the removed portion of the biological sample to a blood or tissue sample and incubating the removed portion of the biological sample with the blood or tissue sample, thereby producing an enriched blood sample. A removed portion of the biological sample can comprise tissue fragments, a platelet poor plasma layer, a buffy layer, an erythrocyte layer, or combinations thereof. The removed portion of the biological sample can be incubated for about 4 hours or more.

### BRIEF DESCRIPTION OF THE DRAWINGS

The accompanying drawings are included to provide a further understanding of the methods and compositions of the disclosure, are incorporated in, and constitute a part of this specification. The drawings illustrate one or more embodiments of the disclosure, and together with the description serve to explain the concepts and operation of the disclosure.

FIGS. 1A-G show a system for motor source driven biological sample processing in an enclosure, according to some embodiments. FIG. 1A shows two tubular containment devices aligned to be disposed into two buckets and a motor source aligned to connect to a shaft. FIG. 1B shows two tubular fluid containment devices disposed in two buckets in a bucket adaptor and a motor source positioned along a shaft. FIG. 1C shows a motor source operably connected to a shaft and secured in place with a stabilizer. FIG. 1D shows an enclosure with one hinged door open and one closed in preparation of use. FIG. 1E shows two containment devices that have rotated from an upright position to a horizontal position while spinning. FIG. 1F shows removal of the two containment devices for biological sample processing. FIG. 1G shows a top view of an aspect of an enclosure with a bar 705 that extends across a face of the enclosure where two portions of the face 702 can move toward and away from the bar to close and open (left panel) or two portions of the face 702 can hinge open (right panel).

FIGS. 2A-C show detailed portions of a system for motor source driven biological sample processing in an enclosure, according to some embodiments. FIG. 2A shows loading, stationary, and spin positions of two tubular containment devices disposed in two buckets, which are balanced at opposite sides within a bucket adaptor. FIG. 2B shows a motor source resting in a stabilizer (left pane) and a motor source secured to a proximal end of a shaft using a stabilizer (right pane). FIG. 2C shows three isolated views of an assembled system for biological sample processing. Two tubular containment devices are in a stationary position and connected to a shaft at a distal end of the shaft. A motor source is connected to the shaft at a proximal end of the shaft and secured to the shaft with a stabilizer.

FIGS. 3A-B show how a disc-like containment device can be used according to some embodiments. In this example, the top and bottom support plates for a variable volume separation chamber are shown. FIG. 3A shows a multi-piece shaft connected to the fluid containment device, which has several sections. A motor source (not shown) can connect to a proximal end of the shaft, the location furthest from the containment device. FIG. 3B shows a closer view of the shaft connected to the fluid containment device.

FIGS. 4A-B show two different images of a motor source control system, according to some embodiments. FIG. 4A shows the screen connected to a handheld device that is the motor source. FIG. 4B shows a closer view of the screen to modulate the RPM, for example, for the motor source.

FIGS. 5A-C show single frame images of videos recording a system using disc-like containment devices (in this case a variable volume separation chamber having a bottom support plate), according to some embodiments. FIG. 5A shows a device at 500 RPM. FIG. 5B shows a device at 4000 RPM. FIG. 5C shows a device at 8000 RPM. In these embodiments an enclosure is not used, but an enclosure can be used if desired.

FIG. 6 shows an example of a disc shaped containment device.

FIG. 7 shows an example of a variable volume separation chamber having both a top support plate 800 and a bottom support plate 810. In an aspect, only a bottom support plate 810 is used.

### DETAILED DESCRIPTION

### Overview

Provided herein are systems and methods for concentration, purification, and fractionation of biological samples that are distinct from the use of standard medical grade centrifuges or benchtop microcentrifuges. Standard centrifuge devices can contain heavy fixed angle rotors configured to hold samples in place for centrifugation. These fixed angle rotors are cumbersome and must be switched out for different sample containment devices sizes (e.g., different tube volumes). Furthermore, it can take time to change the speed of a centrifuge. Accordingly, systems and methods are provided herein for easy to use, lightweight, and quick, biological sample concentration, purification, and fractionation. The present systems and methods make use of devices already possessed by practitioners, for example, in the laboratory, operating room, or surgical suite such as a surgical drill, a dental drill, or handpiece, a pneumatic drill, shaver or handpiece, or any other suitable device. Systems and methods provided herein provide light weight devices that can be quickly use for biological sample concentration, purification, and fractionation.

System for Biological Sample Concentration, Purification, and Fractionation

Systems for biological sample concentration, purification, and fractionation comprising, for example, one or more containment devices, a motor, a shaft, and a stabilizer are provided herein.

Containment Device

A device described herein can include one or more containment devices 200. A containment device can receive and hold biological fluid throughout a variety of concentration, purification, and fractionation processes. In some embodiments, one or more containment devices can be a tubular vessel such as a test tube, centrifuge tube or bottle, microcentrifuge tube, syringe, double syringe (see e.g., U.S. Pat. No. 10,512,659), triple syringe (see, e.g., US Pat. Publ. US 20210220543), a disc-like apparatus, or any other suitable containment device such as those described in US Pat. Publ. US 2017/0000826 A1. One or more containment devices and/or adaptors for containment devices can be disposed at a distal region of a shaft below a motor source connected to the same shaft. When connected to the shaft a motor source can spin the shaft, which in turn spins the containment devices and/or adaptors.

In some embodiments, one or more containment devices can include a double or triple syringe system that can include a first syringe body (an outer tube provided with a luer-style connector (i.e., a slip tip connector) and a rubber gasket to allow connection to additional structures/syringes) and a plurality of additional syringes (e.g., 1, 2, 3, or more) that are designed to connect with the first syringe. In some embodiments, the plurality of additional syringes can connect with the first syringe in sequence to withdraw various effluent fractions from the first syringe. In some embodiments, each of the additional syringes has a diameter smaller than that of the first syringe, to allow the body of the additional syringes to be at least partially within the body of the outer one. The additional syringes can be provided as an integral unit with the first syringe body (i.e., may be nested within each other) or can be provided as separate units that can be connected to the first syringe body. A containment device can be formed of materials such as glass or plastics, including but not limited to, polyolefins, polystyrene, polyallomer, polypropylene, polyvinyl chloride, polyethylene terephalate glycol modified, and polycarbonate.

In some embodiments, a containment device can include one or more inlet ports, one or more outlet ports, or combinations thereof that can be configured to be used to introduce and remove biological sample from the containment device.

One or more inlet or outlet ports can include luer-style connectors (i.e., a slip tip connector) so that devices such as syringes and needles can easily be attached to the containment device. A user can introduce fluid to a containment device prior to, for example, concentration, purification, and fractionation processes. Upon actuation of a motor source the one or more containment devices can be spun in conjunction with one another. Once stopped, a user can access a desired portion of a biological sample within the one or more containment devices via an outlet port or other opening.

In some embodiments, one or more containment devices 200 can be two or more (e.g., 2, 3, 4, 5, 6, 7, 8, 9, 10, 11, 12, 13, 14, 15, or more) tubular vessels. Two or more tubular vessels can be counter disposed at a distal region of a shaft which is a region below the shaft where a motor source connects. In some embodiments, two or more tubular vessels can be counter disposed at a location on a distal portion of a shaft (e.g., a portion of a shaft that is below where a motor source connects to the shaft). In some embodiments, a blank (e.g., a tubular vessel that does not contain a biological sample) can be used so that the one or more tubular vessels containing biological sample can be balanced when spinning. One or more tubular vessels can include a lid, one or more inlet ports, one or more outlet ports, one or more vents, or combinations thereof. A lid can be removably attached to one or more tubular vessels used for biological sample concentration, purification, and fractionation. A lid can be metal, cork, plastic, glass, or any other suitable material. A lid can be threaded, snap on, push in, or any other suitable means of attachment. A tubular vessel can hold about 0.5 mL to about 100 mL (e.g., about 0.5, 1, 2, 3, 4, 5, 10, 15, 20, 25, 30, 35, 40, 45, 50, 55, 60, 65, 70, 75, 80, 85, 90, 95 or 100 mL). In some embodiments, a tubular vessel can be a standard microtube which can hold between about 0.5 and 2 mL (e.g., about 0.5, 0.6, 0.7, 0.8, 0.9, 2.0, 1.1, 1.2, 1.3, 1.4, 1.5, 1.6, 1.7, 1.8, 1.9, or 2.0 mL). In some embodiments, a tubular vessel can be larger than a microtube (e.g., about 3, 4, 5, 10, 15, 20, 25, 30, 35, 40, 45, 50, 55, 60, 65, 70, 75, 80, 85, 90, 95, or 100 mL). In some embodiments, there can be two or more tubular vessels (e.g., 2, 3, 4, 5, 6, 6, 7, 8, 9, 10, 11, 12, 13, 14, 15, 16 or more).

In some embodiments, one or more tubular vessels can be housed within two or more buckets 210 capable of receiving the one or more tubular vessels. Two or more tubular vessels can be counter disposed within buckets, wherein the two or more tubular vessels are configured to freely rotate from an upright position to a horizontal position or any angle between upright and horizontal.

A bucket adapter 220 can connect to a distal region of a shaft which is a region opposite an end of a shaft where a motor source connects (e.g., a distal end of a shaft, or a half of a shaft that is opposite the end of a shaft where a motor source connects). A bucket adapter can slide over a shaft, clip onto a shaft, or otherwise attach to a shaft. A bucket adapter can have a hole into which a shaft can slide. A bucket adapter can receive two or more buckets for housing one or more tubular vessels. A bucket adapter can have arms radiating from a center of the bucket adapter, which are configured to hold two or more buckets. In some embodiments, a bucket adapter can have movable arms, removable arms, or other means of accommodating more or fewer buckets. A bucket adapter can have a locking mechanism to fix it in place along a distal region of a shaft or at a distal region of a shaft. When connected, a bucket adapter can rotate in conjunction with a shaft and a motor source to rotate two or more buckets and their contents (e.g., tubular vessels containing biological sample). Prior to, or upon actuation of, a motor source, one or more buckets can rotate freely from a vertical position to a horizontal position and any position therebetween. In some embodiments, there can be more than two buckets (e.g., 2, 3, 4, 5, 6, 7, 8, 9, 10, 11, 12, 13, 14, 15, 16, or more).

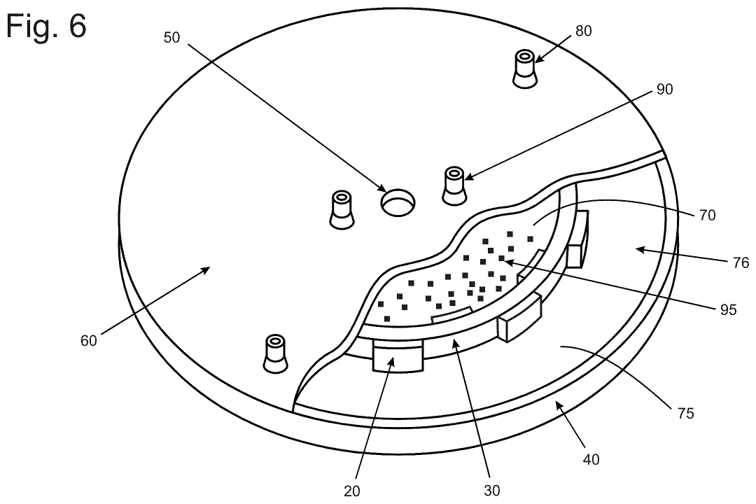

In some embodiments one or more containment devices can be a disc shaped device. A disc shaped device can include a top plate 60, a bottom plate 76, and an outside wall 40. See e.g., FIG. 6. The device can be about 1, 2, 3, 4, 5, 6, 7, 8, 9, 10, 15 inches or more in diameter and about 0.1, 0.2, 0.3, 0.4, 0.5, 0.6, 0.7, 0.8, 0.9, 1.0, 2.0 inches or more in thickness. The top plate, bottom plate, and outside walls can also have inner and outer surfaces. The outside wall can further connect the top and bottom plates. A disc can be configured so that the inner surfaces of the top and bottom plates face one another. A disc can form a compartment enclosed by the inner surfaces of the top plate, bottom plate, and outside wall. In some embodiments, a compartment can further incorporate one or more filter elements or membranes 30. A filter element or membrane can aid in the filtration, concentration, purification, separation, or any other means of processing a biological sample. In some embodiments, the filter element or membrane can include a rough filter, a granular filter, or any other suitable filtration material.

The filter element or membrane can be positioned so that the filter element or membrane separates a compartment enclosed by the inner surface of the top plate, the inner surface of the bottom plate, and the inner surface of the outside wall of the apparatus. The filter element or membrane separates the compartment so that the device comprises a pre-membrane compartment or inner compartment 70, and an outer compartment or post-membrane compartment 75. The pre-membrane compartment encompasses the central area and can be surrounded by the filter element or membrane 30. The post-membrane compartment 75 can be located between the filter element or membrane and the inner surface of the outside wall 40 of the apparatus. A filter element or membrane can comprise an inside edge and an outside edge, can be circular in shape, continuous, and encircle an inner compartment. The inner compartment can be surrounded by the inside edge of the at least one filter element or membrane. An outer compartment can be located between the outside edge of the filter element or membrane and the inner surface of the outside wall.

A fastener or holder can be present to hold the membrane or filter element in place. In an aspect, a fastener or holder can comprise struts 20 that extend into the compartment enclosed by the inner surface of the top plate, the inner surface of the bottom plate, and the inner surface of the outside wall of the apparatus. The struts act to hold the filter element or membrane in place. The struts allow for the weaving or attachment of the filter element or membrane, securing the filter element or membrane in place.

The central area can comprise the inner compartment as well as a center shaft attachment point 50. The center shaft attachment point can be any shaped hole that can accept a shaft. The center shaft attachment point can comprise teeth that can engage with the shaft or an attachment device that attaches the disc shaped apparatus to the shaft. The inner compartment can be donut shaped surrounding the center shaft attachment point.

A filter can encircle a first inner compartment forming the inner compartment 70 and an outer compartment 75. In an aspect biological fluid can be loaded into the inner compartment through an inlet port (e.g., 90) in the top or bottom plate. Once the disc shaped device is spun, the fluid will be forced through the filter and into the outer compartment. The purified, enriched, or concentrated biological fluid can be removed from the outer compartment through an outlet port (e.g., 80) in the top or bottom plate.

In an aspect, a scaffold 95 can be present in an inner compartment, and outer compartment, or both. The scaffold can be comprised of any one, or a combination, of the following: a plurality of beads, spheres, gels, wool, powder, granules, particles, autograft, allograft, or xenograft mammalian bone, and/or mammalian tissue including, but not limited to, muscle, cartilage, tendon, vascular tissue, organ tissue, adipose tissue and the like. The beads, spheres, gels, wool, powder, granules, and particles can be made of, for example, glass, plastic, corundum, and/or quartz. The surface area of the scaffold can be increased by etching the surface of the beads, spheres, granules, and particles through methods known in the art. The scaffold can be held in place by a housing, such as a cassette or holder. Such a housing could comprise the same type of material as the scaffold, glass, plastic, corundum, and/or quartz, or any combination. The scaffold can also be loose in the body fluid reservoir. The scaffold can be the inner surface of the top plate and/or the inner surface of the bottom plate and comprise etches, ribs, or ridges on these surfaces.

A scaffold can increase solid surfaces exposed to the fluid. Where the fluid is a biological fluid, the higher surface area can allow cells in the body fluid to attach to the scaffold. Once attached, the cells can produce therapeutic factors. In one example, monocytes can adhere to the scaffold. The attachment of monocytes stimulates monocyte production of therapeutic factors, for example but not limited to, IL-1ra, fibrinogen, thrombin, and alpha-2-macroglobulin. In another example, thrombocytes attach to the scaffold device and stimulate production of therapeutic factors such as platelet derived growth factor (PDGF). The body fluid can be derived from mammalian tissue, such as but not limited to, liver, cartilage, bone, muscle, and the like. Additionally, the body fluid can comprise cells derived from mammalian liver. These cells can adhere to the scaffold and produce fibrinogen and thrombin.

Therefore, a device can not only filter and concentrate therapeutic factors, but it also can expand or multiply the amount of therapeutic factors such that there are more therapeutic factors in the therapeutic fluid than were present in the bodily fluid. The therapeutic fluid can comprise 5, 10, 15, 20, 30, 40, 50, 60, 70, 80, 90% or more therapeutic factors than were present in the starting bodily fluid. The therapeutic fluid can contain 0.5, 1, 2, 3, 5, 10 or more times the amount of therapeutic factors in the therapeutic fluid than were present in the starting bodily fluid

In an aspect, a tissue such as muscle, tendon, cartilage, bone fragments, or adipose tissue can be added to the inner compartment. Biological fluid then can be loaded into the inner compartment through an inlet in the top or bottom plate. The biological fluid can then be incubated with the tissue for 5, 15, 30, 45, 60, 120, 180 or more minutes. The disc shaped device can be spun so that the fluid will be forced through the filter and into the outer compartment. The tissue will be retained in the inner compartment by the filter. This method can be used to enrich and/or concentrate biological fluid. In an aspect the amount of, for example, interleukin-1 receptor antagonist (IL-1ra) can be enriched in the biological fluid. The enriched and/or purified biological fluid can be removed from the outer compartment through an outlet in the top or bottom plate.

In an aspect, 2 or more filters (e.g., 2, 3, 4, 5 or more) can encircle the disc shaped device creating 3, 4, 5, 6, or more compartments within the device.

One or more containment devices can be made of polypropylene or any other suitable solid, nonabsorbent material, and can be partially or fully translucent for visibility. One or more containment devices can be designed to further include graduated marks for measuring a volume of tissue fragments collected in the one or more containment devices.

In some embodiments, one or more containment devices can include a filter. A filter can have any shape, configured such that a filter comprises one or more side walls and a base. For example, a filter can have a circular section, and be a cup-shaped filter or a cylindrical or tubular filter having a single side wall and a circular base; a filter can have triangular section shape, and have three side walls and a triangular base; a square or rectangular section shape, and have 4 side walls and a square or rectangular base. However, other shapes are possible for the filter, including for example, a hexagon, or an ovoid.

A base of a filter, one or more side walls of a filter, or both a base and one or more side walls of a filter can include a filter material, a perforated solid material, or a combination of a filter material and a perforated solid material. A solid material can include polystyrene or another solid, nonabsorbent material, and can be partially or fully translucent (e.g., for visibility). A solid material that is perforated can include a large number (e.g., 10, 20, 30, 40, 50, 60, 70, 80, 90, 100, 120, 140, 160, 180, 200, 210, 220, 240, 260, 280, 300, or more) of small holes to provide an effective flow communication between an interior of the one or more containment devices and an interior of the filter, without allowing tissue fragments to pass through the holes. The filter material can include a membrane or a mesh having pores, which can have varying size. The solid filter material can include, for example, metals or plastics, like titanium, stainless steel, polyethylene, polytetrafluoroethylene PTFE, polyvinylidene fluoride (PVDF), nylon, polypropylene (PP), polyester, polycarbonate, polyethersulfone, cellulose acetate, polyimide, or another suitable material. A filter can have a pore size ranging from about 50 microns to about 1000 microns. For example, a filter can have about 50 micron to about 100 micron pores, about 100 micron to about 200 micron pores, about 200 micron to about 300 micron pores, about 300 micron to about 400 micron pores, about 400 micron to about 500 micron pores, about 600 micron to about 600 micron pores, about 600 micron to about 700 micron pores, about 700 micron to about 800 micron pores, about 800 micron to about 900 micron pores, or about 900 micron to about 1000 micron pores.

A filter can be configured to retain tissue fragments inside one or more containment devices. In other words, a filter can include pores having a size compatible with the size of the tissue fragments liberated and collected.

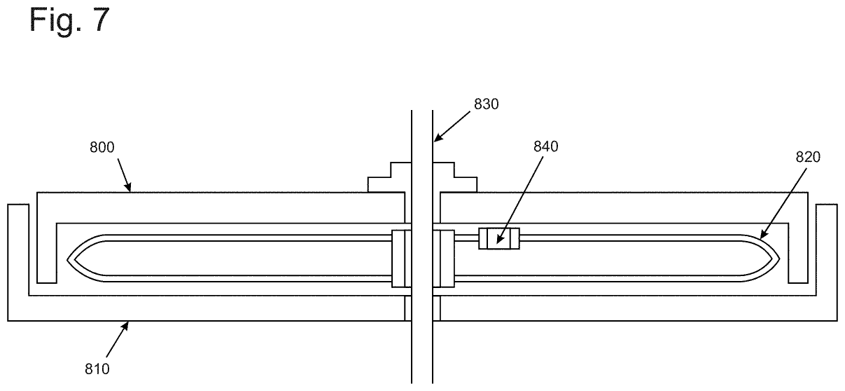

In an aspect a containment device can be a variable volume separation chamber similar to that described in, for example, U.S. Pat. No. 7,407,472. A variable volume separation chamber (see FIG. 7) can comprise a disk-shaped bag 820 (e.g., a flexible polymer bag) having a hole in the middle to accommodate a shaft. A variable volume separation chamber can be present in association with a bottom support plate 810 and/or a top support plate 800. In an aspect only a bottom support plate is used. In an aspect only a bottom support plate is used. The variable volume separation chamber can be about 1, 2, 3, 4, 5, 6, 7, 8, 9, 10, 15 or more inches in diameter. When loaded with fluid, the variable volume separation chamber can be about 0.1, 0.2, 0.3, 0.4, 0.5, 0.6, 0.7, 0.8, 0.9, 1.0 inches or more in thickness. One or more ports 840 can be present in any position on a variable volume separation chamber.

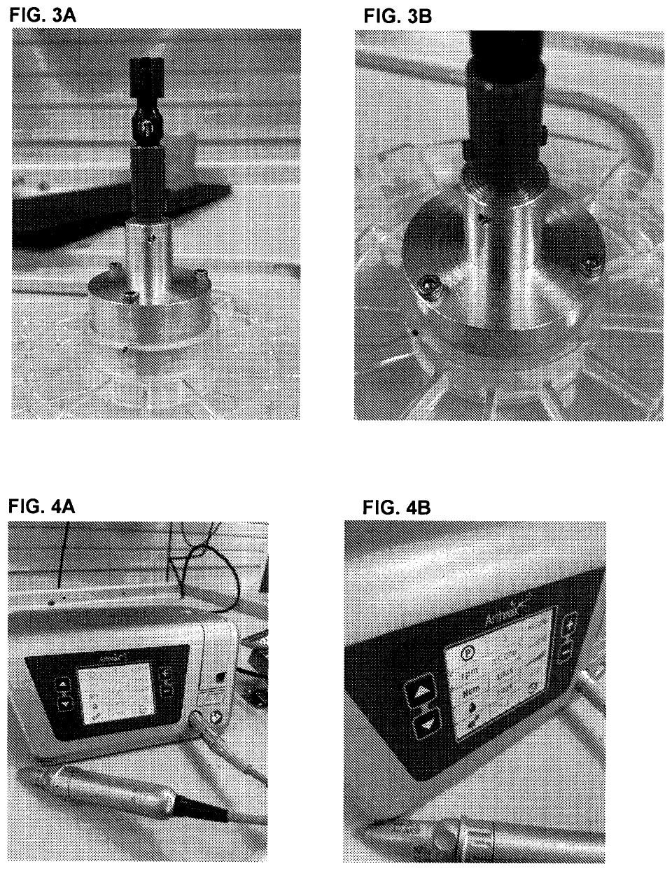

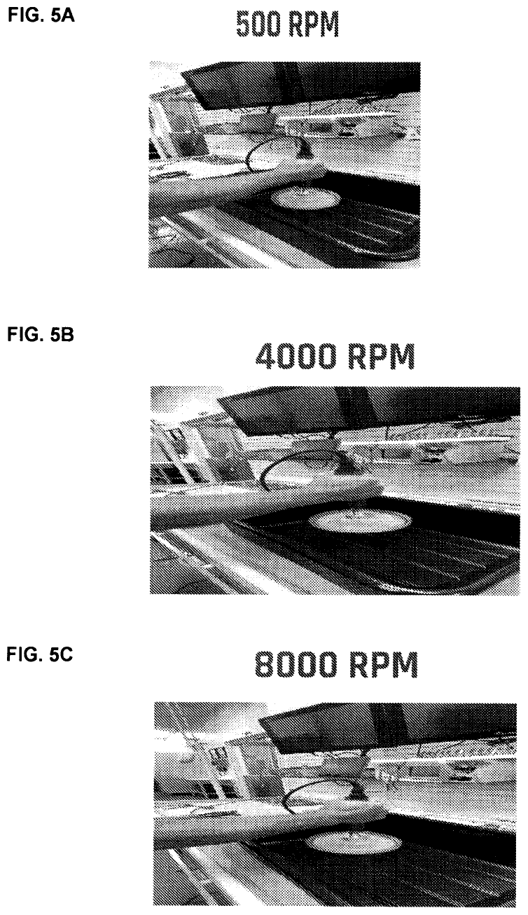

An adapter can be used to connect the variable volume separation chamber, top plate and bottom plate to a shaft. See. FIG. 3. An axial inlet/outlet for biological fluids can be attached to the bottom or top support plate or both plates by a rotating seal assembly. A variable volume separation chamber can be mounted between the bottom support plate and the top support plate, the variable volume separation chamber being fluidly connected to the axial inlet/outlet. The top and bottom support plates can be locked together to hold the variable volume separation chamber. After processing the axial inlet/outlet can be connected to a container of biological fluid and to one or more containers for receiving separated components of the biological fluid. In an aspect only a bottom support plate is used.

In some aspects, fluid pressure inside the rotating variable volume separation chamber increases with increased gravitational force and the addition of biological fluid such as whole blood. Once adequate separation of the biological fluid components occurs, the hand held motor rotation speed can be decreased.

A shaft can be connected to a variable volume separation chamber or, where used, the bottom support plate or the top support plate. The variable volume separation chamber bottom support plate or the top support plate can each have a hole in the center which can be used to connect to the shaft.

In an aspect a biological fluid, such as whole blood can be processed by introducing a quantity of biological fluid into the variable volume separation chamber and spinning the device to separate the biological fluid components. The heavier components migrate to the outer portions of the separation chamber while the lighter components remain near the center of the separation chamber. During the spin, where whole blood is used as the fluid, lower density blood components accumulate in the center region that is, close to the axis of rotation, while higher density components are urged toward the outermost region. The separated components of the fluid can be removed through the axial inlet/outlet.

Biological Sample

As used herein, a “biological sample” is a biological fluid and/or biological tissue collected from a subject. The subject can be a mammal, including but not limited to human, equine, canine, feline, bovine, porcine, rodent, sheep, or goat. A biological fluid can be autogenic, allogenic, or xenogenic. Biological fluids include, but are not limited to, whole blood, plasma, serum, urine, saliva, mucus, synovial fluid, cerebrospinal fluid, lymphatic fluid, seminal fluid, amniotic fluid, vitreous fluid, as well as fluid collected from cell culture of patient cells, and the like. Biological fluids also include tissues or fluids derived from tissue such as, for example, adipose tissue, bone, bone marrow, muscle, brain, heart, liver, lung, stomach, small intestine, large intestine, colon, uterus ovary, testis, cartilage, soft tissue, skin, subcutaneous tissue, breast tissue, tissue obtained from other species, patient tissue from surgery, and the like. The tissue can be disrupted. Methods for disrupting tissue are known and include homogenization and enzymatic treatments. Biological fluids also include, for example, bone marrow, fluids obtained from surgery, fluid filtrates, tissue filtrates or fragments, bone chips or fragments obtained during surgery, and the like. Biological tissue can include tissue such as, for example, bone, bone marrow, muscle, brain, heart, liver, lung, stomach, small intestine, large intestine, colon, uterus ovary, testis, cartilage, soft tissue, skin, subcutaneous tissue, breast tissue, tissue obtained from other species, patient tissue from surgery, and the like.

A biological sample can include one or more growth factors. A growth factor is a bioactive molecule that promotes proliferation of a cell or tissue. Useful growth factors include, but are not limited to, transforming growth factor-alpha (TGF-alpha), transforming growth factor-beta (TGF-beta), platelet-derived growth factors including the AA, AB and BB isoforms (PDGF), fibroblast growth factors (FGF), including FGF acidic isoforms 1 and 2, FGF basic form 2, and FGF 4, 8, 9 and 10, nerve growth factors (NGF) including NGF 2.5s, NGF 7.0 s and beta NGF and neurotrophins, brain derived neurotrophic factor, cartilage derived factor, bone growth factors (BGF), basic fibroblast growth factor, insulin-like growth factor (IGF), vascular endothelial growth factor (VEGF), EG-VEGF, VEGF-related protein, Bv8, VEGF-E, granulocyte colony stimulating factor (G-CSF), insulin like growth factor (IGF) I and II, hepatocyte growth factor, glial neurotrophic growth factor (GDNF), stem cell factor (SCF), keratinocyte growth factor (KGF), transforming growth factors (TGF), including TGFs alpha, beta, beta1, beta2, and beta3, skeletal growth factor, bone matrix derived growth factors, and bone derived growth factors and mixtures thereof. Some growth factors can also promote differentiation of a cell or tissue. TGF and VEGF, for example, can promote growth and/or differentiation of a cell or tissue. Some growth factors include VEGF, NGFs, PDGF-AA, PDGF-BB, PDGF-AB, FGFb, FGFa, and BGF.

A biological sample can include tissue fragments, which can refer to fragments, pieces, or debris obtained from a tissue. Tissue fragments can be obtained, for example, during surgery or fluid collection. The tissue can be, e.g., soft tissue, bone or cartilage; and the tissue fragment can include bone or cartilage filtrates or fragments, bone/cartilage chips or fragments, or any other type of tissue pieces that can result from the treatment provided at the surgical site, obtained during surgery. The soft tissue can be tendon, ligament, muscle, adipose, or fascia. The surgical site can be a joint, such as a knee, a shoulder, an ankle, an elbow, a hip, or a wrist. The tissue fragments can be collected for autologous graft.

A biological sample can be a blood sample (e.g., whole blood, plasma, serum) or a fraction thereof (e.g., PRP, platelet poor plasma, buffy coat, white blood cells, red blood cells, which. A blood sample can contain a representative number of the major cells in a subject's blood, such as white blood cells, red blood cells, and platelets. The blood sample can be a non-anticoagulated blood sample or an anticoagulated blood sample.

A biological sample can be processed using processes including but not limited to a concentration process, an enrichment process, a purification process, a fractionation process, a separation process, a filtration process, an extraction process, or any combination thereof.

In some embodiments, the biological sample (e.g., tissue or fluid), can be concentrated. Sample concentration is the increase in one or more components of a biological sample. In some embodiments, concentration can involve removing (e.g., discarding) excess solution, increasing the amount of a desired component (e.g., growth factor) in volume, or combinations thereof. The amount of the increase can be, for example, about 1, 5, 10, 20, 30, 40, 50, 60, 70, 80, 90, 100% or more as compared to the starting biological fluid. A concentrated sample can also be enriched, meaning that the amount of one or more components (e.g., desired therapeutic factors) in the biological fluid are increased to produce a therapeutic fluid (e.g., a “concentrated therapeutic sample” or an “enriched therapeutic sample”) The amount of the increase can be, for example, about 1, 5, 10, 20, 30, 40, 50, 60, 70, 80, 90, 100% or more as compared to the starting biological fluid.

The term “therapeutic fluid” means a biological fluid that has been enriched, concentrated, purified, or fractionated such that it has a higher concentration of one or more therapeutic factors than present in the starting biological fluid. As used herein, “therapeutic factors” are components of mammalian biological fluid that can be used as therapeutics, for example, growth factors, differentiation factors, chemotactic factors, adhesion molecules, anti-inflammatories, globulins, and other proteins that can be used as therapeutics such as interleukin-1 receptor antagonist (IL-1ra), thrombin, and alpha-2 macroglobulin. Therapeutic fluids can also include, but are not limited to, autologous conditioned bone marrow concentrate (ACBMC), blood fractions (platelet rich plasma (PRP), platelet poor plasma (PPP), leukocyte-reduced PRP), stem cells (cord blood-derived and bone marrow-derived) for example, concentrated seminal fluid, concentrated spinal fluid, and the like.

In some embodiments, a biological sample can be purified. Purification is a series of processes intended to isolate or concentrate one or more components from a biological sample.

In some embodiments, the biological sample (e.g., tissue or fluid), can be fractionated. The term “fraction” refers to the various components into which a biological fluid can be separated by devices disclosed herein, gravitational weight separation, or filtration. A fractionated biological sample can be a separated biological sample in that component parts are disaggregated. Every fraction can be enriched or concentrated with a particular fluid component relative to the other fractions and the original fluid. Furthermore, a concentration process can remove one or more nonessential components from the biological fluid. The concentration process can also remove nonessential components such that the concentrated fraction contains desired components. In some embodiments, a biological fluid can be filtered prior to, during, or after fractionation.

In some embodiments, a biological sample can be filtered to remove particles, tissue, and the like. Filtration is the process of separating suspended particles from the fluid through a porous material in which the fluid can pass while the suspended particles are retained.

Motor Source

A device described herein can include a motor source 401, which is a device that can spin, wherein the rate of speed of spinning can be modulated or controlled by the user. In some aspects, the rate of speed can be adjusted or changed without shutting the motor source down and/or without stopping the motor source. A motor source can be, for example, a brushless DC motor or a brush DC motor. A motor source can be a handheld motor source. A motor source can use a motor that rotates at various selected speeds ranging from 10 rpm to 100,000 rpm and have a power regulation of about 10 to about 500 watts. For example, a typical micro drill can have a rotational speed of about 10,000 to 40,000 RPM and require a relatively small power of about 40 watts. A motor source can generate a torque, which can change as a function of the speed of the motor source. A motor source can comprise a surgical device like a drill, handpiece, shaver, dental device, or any other suitable device.

A motor source can include systems such as, but not limited to, the Arthrex DrilISaw Max 600 System, the Arthrex DrillSaw Mini 300 System, the Arthrex DrillSaw Sports 400 System, the Arthrex SynergyResection Console Shaver System, a medical drill, a pneumatic drill, a dental drill, surgical shavers, or any other suitable handpiece.

Surprisingly, it has been found that surgical drills, handpieces, shavers, and other suitable non-centrifuge surgical devices can generate sufficient g-force to fractionate, concentrate, and purify samples. Additionally, these devices can adequately separate biological samples while spinning around its own center of axis without constraining the user to a specific centrifuge, bucket, or rotor. These devices also offer sufficient stability to separate a biological sample while holding the device in hand. The handheld motor source can be capable of adjusting a first g-force to a second g-force within about 0.5, 1, 2, 3, 4, 5, 6, 7, 8, 9, 10, 11, 12, 13, 14, 15, 16, 17, 18, 19, 20, 30, 40, 50, 60, or 70 seconds without causing the RPM of motor source to reach zero. In other words, the motor source can increase or decrease g-force without stopping such that the one or more containment devices do not have to stop spinning when changing the g-force from a higher g-force to a lower g-force or when changing the g-force from a lower g-force to a higher g-force.

A motor source as described herein can be handheld and is not a centrifuge. Given that the present technology allows the user to control the axis about which the containment device spins, such that the user is not tied to a traditional separation device which generally requires a flat, stable surface on which it must rest. Traditional centrifuges and other separation devices take up valuable space in labs and not always available in surgical suites or operating rooms. The present technology helps to solve this problem by offering the user the ability to process biological samples anywhere, without having to sacrifice benchtop or other lab space to a centrifuge.

A motor source can connect to a shaft at a proximal region of a shaft (e.g., a top end or top region of a shaft). One or more containment devices can be connected to the shaft below the motor source and can spin about its own axis. As a result, the axis around which a containment device spins can change depending on where the user positions a shaft and a motor source. This differs from that of a centrifuge because a centrifuge Is typically stationary while the device is spinning a containment device. In an aspect, a shaft is removable from a motor source.

Gravitational force equivalent “g-force” is a measurement of the type of force per unit mass—typically acceleration—that causes the perception of weight. G-force, in the context of the present disclosure, is dependent upon (1) rotations per minute “rpm” exerted on a containment device by a motor; and (2) the radius of a containment device. Separation of some biological sample often requires one to subject a sample to varying g-forces for different amounts of time. In some embodiments, a motor source can spin a containment device at a rate of rotations per minute (RPM) sufficient to create a desired g-force. In some embodiments, the g-force in the centrifugation step can be no greater than about 100,000×g, in some embodiments, no greater than about 50,000×g, and in some embodiments, no greater than about 1,000×g (e.g., about 1,000, 5,000, 10,000, 20,000, 30,000, 40,000, 50,000×g or more. The present disclosure further allows the user to make adjustments to RPM and, in turn, the g-force exhibited on a sample at will, and within seconds.

A motor can be attached to a proximal region of a shaft. One or more containment devices can be attached at a distal region of a shaft and the one or more containment devices can receive a biological sample. Upon actuation, a motor can spin a shaft which, in turn, spins a containment device at the same rate.

Shaft

A shaft can be a narrow, elongated rod that can be rotatably coupled, at a proximal region, to a motor source and/or a stabilizer 501. In some embodiments, a shaft is a multi-piece unit that connects one or more containment devices at a distal end and a motor source at a proximal end of a multi-piece shaft. A distal region of a shaft can be coupled to one or more containment devices or other suitable attachment. Upon activation of a motor source, a shaft can rotate at the same rate as a motor source which, in turn, rotates a containment device (or an attachment of a containment device, such as a bucket system) at a distal region. The shaft can be made of plastic, metal, or any other suitable material thereof. A cross section of a shaft can be circular, triangular, square, hexagonal, pentagonal, octagonal, or any polygon. In some embodiments, a cross section of a shaft can have a slot in which to fit a bucket adapter. A shaft can have a diameter for about 0.3 cm to about 8 cm (e.g., about 0.3, 0.4, 0.5, 0.6, 0.7, 0.8, 0.9, 1, 2, 3, 4, 5, 6, 7, or 8 cm).

A shaft can be removable from one or more containment devices and can be removable from a motor source.

A shaft can be disposed into a heavy base 601 at a distal end to stabilize the device. In some embodiments, a shaft can be disposed in a heavy base to stabilize one or more containment devices throughout processing of a biological sample. A heavy base can include coupled, moveable, and/or non-moveable portions. Moveable portions of a heavy base can spin in conjunction with a containment device and a shaft. Non-moveable portions of a heavy base can remain still and provide stability to both moveable portions of a heavy base and a containment device throughout the separation process. In some aspects a base contains a hole or depression that fits the distal end of the shaft. Once in the hole or depression, the shaft will be prevented from moving laterally, which will give more control to the user. A heavy base can be circular, squared, pointed, or any other shape capable of providing stability to a device disclosed herein throughout the concentration, purification, or fractionation of a biological sample. A heavy base can be formed of metal, plastic, or any other suitable material. A heavy base can weigh between 5 and 100 lbs. (e.g., about 5, 10, 15, 20, 25, 30, 35, 40, 45, 50, 55, 60, 65, 70, 75, 80, 85, 90, 95, or 100 lbs.). In some embodiments, the heavy base is not hand-held.

Stabilizer

A stabilizer 501 can be used to hold a motor source in place while processing a biological sample. A stabilizer can prevent the motor source from vacillating, wobbling, or reverberating, while in use for biological sample processing. A stabilizer can be a chuck, a molded clip, clamp, or any other suitable means of stabilizing a connection between a shaft and a motor source. In some embodiments the stabilizer can have one or more components configured, for example, for a motor source to rest in a portion of a stabilizer and configured to secure using a chuck, a molded clip, a clamp, or any other suitable means of stabilizing a connection between a shaft and a motor source. In some embodiments, a stabilizer can be configured as an adapter to adapt a motor source to operably connect to a shaft. A stabilizer can maintain and secure a connection between a motor source and a shaft throughout spin processes of a biological sample.

Enclosure

Spill Proof Housing

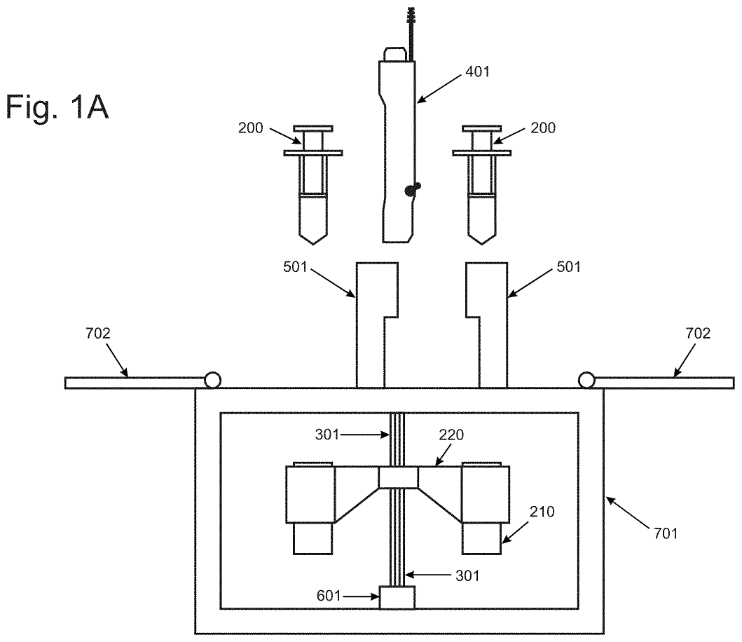

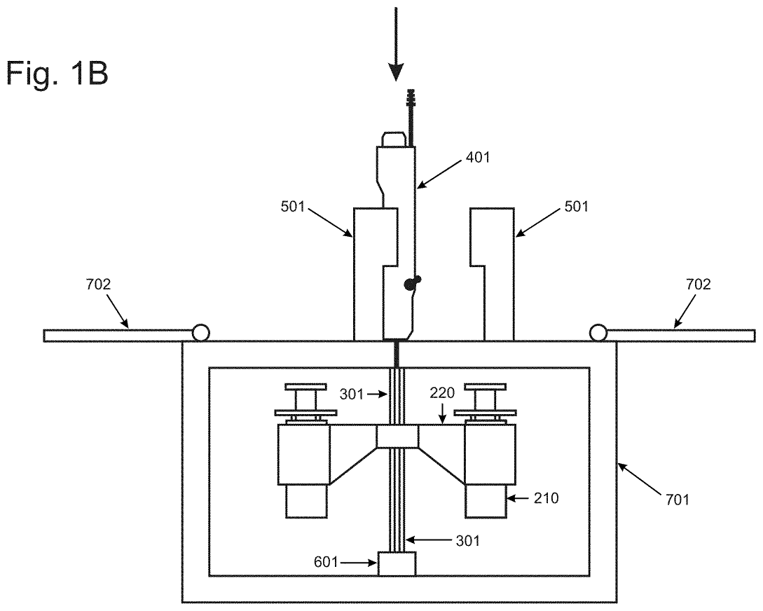

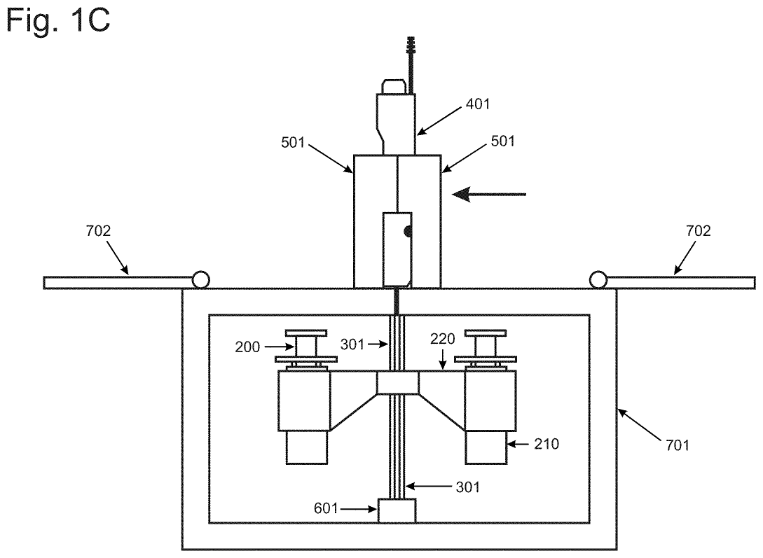

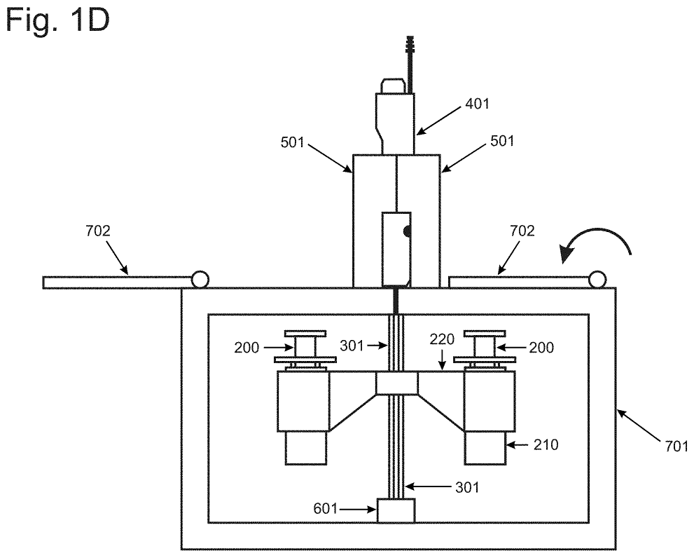

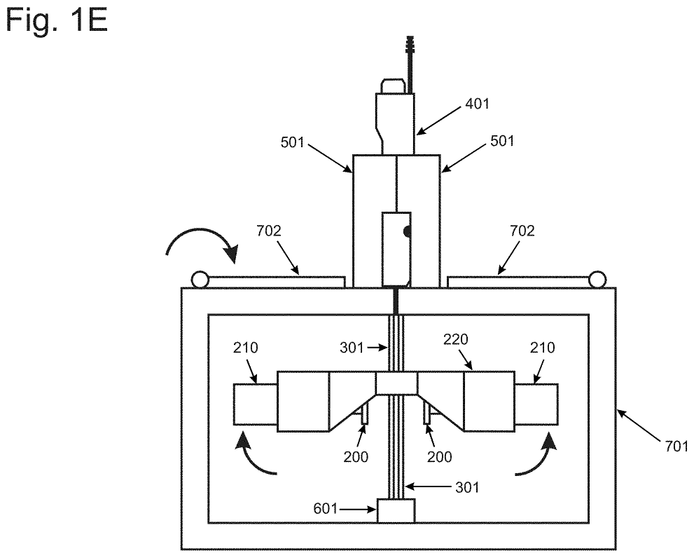

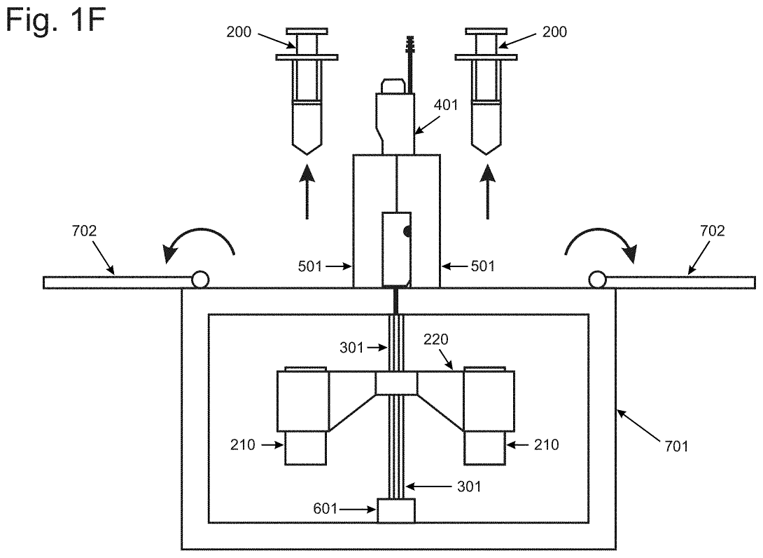

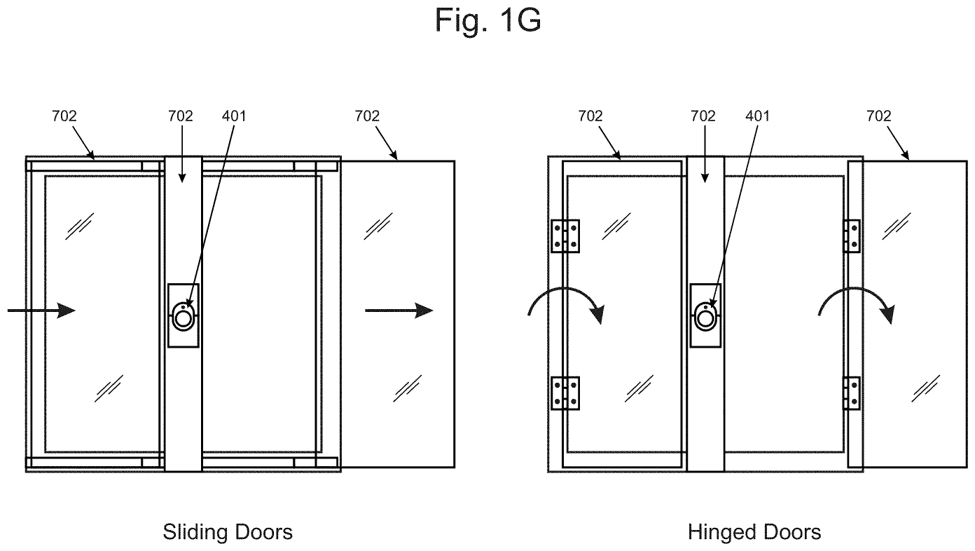

In some embodiments, devices described herein can include an enclosure 701, which can be a spill proof housing. See, e.g., FIG. 1. In some embodiments, a distal portion of the shaft and the one or more containment devices can be housed within an enclosure during the processing (e.g., concentration, purification, and or fractionation) of a biological sample. An enclosure can include a base as described here for additional stabilization. An enclosure can protect the user and its surroundings from spills, leaks, or any other scenario in which biological sample escapes from one or more containment devices during processing. In some embodiments, an enclosure can include one or more faces include a top, bottom, or one or more sides (e.g., 1, 2, 3, 4, 5, 6, 7, 8, 9, 10 or more sides). The sides can be curved (e.g., arched), or straight such as in a cube. In some embodiments, an enclosure can have a lid or doors 702 that open (e.g., by sliding or hinging open) from the top, bottom, or sides to input or remove a biological sample (or selected fraction thereof) or one or more containment devices. In some embodiments, an enclosure can secure an opening portion by latches, straps, or any other suitable means. An enclosure can be square, rectangular, cylindrical. or any other suitable shape. An enclosure can be held together by brackets, frames, glue, cement, epoxy, or any other suitable means of attachment.

An enclosure can be made of plastic, glass, plexiglass, metal, or any other suitable material. The faces of an enclosure can be made of one or more materials.

In some embodiments, an enclosure can connect to a stabilizer. In some embodiments, a stabilizer can further connect to a shaft. Upon actuation of a handheld motor source, a shaft and a stabilizer can spin one or more containment devices. In some embodiments, an enclosure can remain stationary while a shaft, a stabilizer, and one or more containment devices spin. In some embodiments, an enclosure can spin upon actuation of a handheld motor source.

In some embodiments, an enclosure can include a bar that extends across a face of the enclosure where one or more portions of the face can move toward and away from the bar to close and open, respectively, one face of the enclosure (e.g., a top face). In some embodiments, one or more portions of the face can move toward and away from the bar in a sliding fashion, moving laterally inward and outward. In some embodiments, one or more portions of the face can move toward and away from the bar hinging from a bar can allow for other elements of the device described herein to attach to the enclosure, such as but not limited to, a shaft that can extend though a bar and a stabilizer can attach to the shaft and/or the bar. In some embodiments, the one or more portions of the face can be glass, plastic, or any other suitable material. In some embodiments, one or more portions of the face can slide over a bar to close or open the face of the enclosure. In some embodiments, one or more portions of the face can slide up to the bar to close that face of the enclosure.

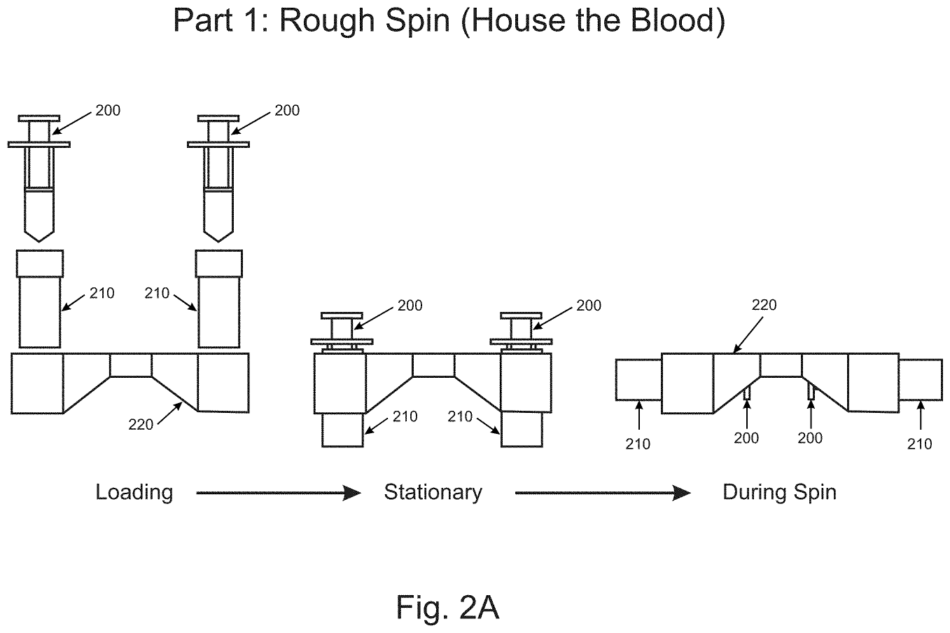

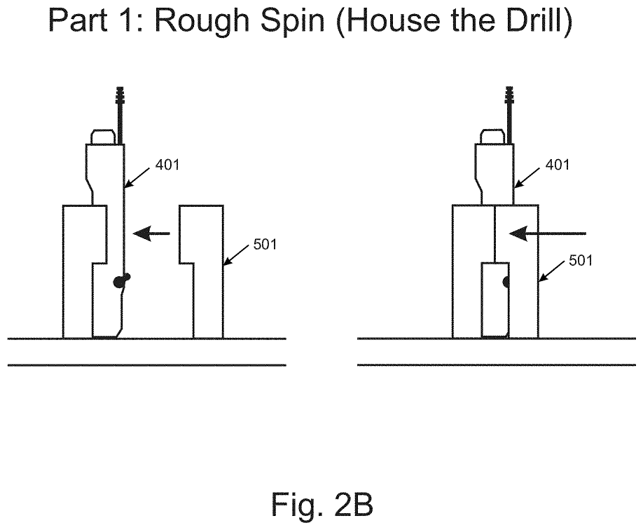

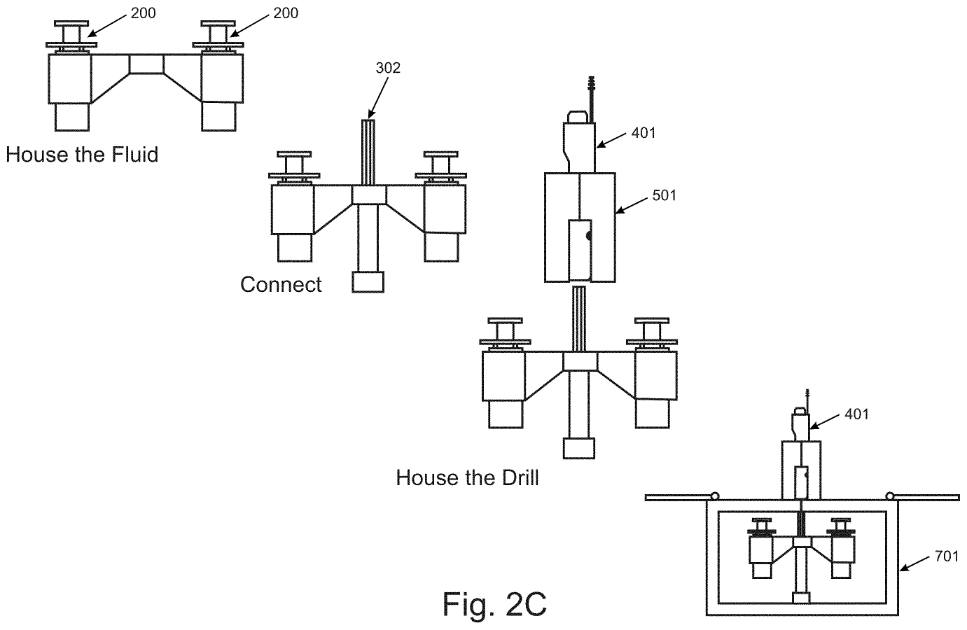

In an embodiment, containment devices 200, such as syringes containing blood, can be placed in two or more buckets 210 capable of receiving the one or more containment devices. See, e.g., FIG. 1A. The two or more buckets can be attached to a bucket adaptor 220. A bucket adaptor can hold the two or more buckets and attach to a shaft 301 such that when the shaft spins, it spins the bucket adaptor and the containment devices within the buckets. 302 the shaft, and bucket adaptor can be present in an enclosure 701 with one or more doors 702 to enclose the bucket adaptor, buckets, containment devices, and part of the shaft during a spin. The doors can hinge open or slide open. A stabilizing device 501 can be used to hold a motor source 401 steady. A base 601 can be present at the bottom of an enclosure. One or more bearings can be present in the base to allow for spinning of the shaft with low friction. A shaft can fit into the base to hold the shaft in position during a spin. FIG. 1B shows the containment devices placed into the buckets and the handheld motor device connected to the shaft. FIG. 1B shows the handheld motor source being connected to one portion of a stabilizing device 501. In this case the stabilizing device comprises two pieces that can be moved together to enclose and stabilize the handheld motor device (see FIGS. 1C and 2B), but any suitable stabilizing device can be used. The stabilizing device can be connected to the enclosure. Once the containment devices are added to the one or more buckets the doors of the enclosure device can be closed. See FIG. 1D, 2C. Once closed the handheld motor device can be activated such that the shaft spins, thereby spinning the bucket adaptor. See FIG. 1E. FIG. 2A shows the loading of the containment devices into the one or more buckets and the loading of the buckets into the bucket adaptor. During the spin the bucket adaptor allows the buckets to swing outward. Once the spin is completed, the doors of the enclosure can be opened and the containment devices can be removed and processed. See e.g., FIG. 1F.

Methods of Use

Also provided are methods of using the devices described herein. Methods can include inserting a biological sample into one or more containment devices connected to a shaft, activating a motor source connected to a shaft, removing the one or more containment devices, and collecting a biological sample or a portion thereof from the one or more containment devices. In some embodiments, methods of biological sample concentration, purification, and fractionation are provided.

Also provided are methods of using the devices described herein, for purification of a biologic sample. Purifying a biological sample can include (a) placing a biological sample within one or more containment devices and connecting them to a shaft, (b) attaching a handheld motor source to the shaft and activating the motor source to spin the shaft and the one or more containment devices, (c) allowing the biological sample to spin at one or more rate(s) of rotations per minute for a set period of time or times, and (d) removing the biological sample or portion thereof from the one of more containment devices. In some embodiments, the containment device can be removed from the shaft prior to removing the biological sample from the containment device. In some embodiments, the biological sample can be passed through a filter within the containment device. In some embodiments, a biological sample can be spun at one or more rates or rotations per minute. In some embodiments, a biological sample is spun at a rate of rotations per minute before subsequently being adjusted to spin at a different rate of rotations per minute. This change can be made without stopping the handheld motor source. In some embodiments, a removed portion of the biological sample can comprise, for example, tissue fragments, a platelet poor plasma layer, a buffy layer, an erythrocyte layer, or any other biologic fluid. In some embodiments, steps (b)-(d) can be repeated 20 or more times (e.g., 1, 2, 3, 4, 5, 6, 7, 8, 9, 10, 11, 12, 13, 14, 15, 16, 17, 18, 19, 20, or more times).

Also provided are methods of using the devices described herein, for concentration of a biologic sample. Concentrating a biological sample can include (a) placing a biological sample within one or more containment devices and connecting them to a shaft, (b) attaching a handheld motor source to the shaft and activating the motor source to spin the shaft and the one or more containment devices, (c) allowing the biological sample to spin at one or more rate(s) of rotations per minute for a set period of time or times, (d) removing the biological sample or portion thereof from the one of more containment devices, and (e) discarding the removed portion of the biological sample and/or increasing one or more components of the biological sample in the sample, thereby concentrating the biological sample. In some embodiments, the biological sample can be passed through a filter. In some embodiments, a biological sample can be spun at one or more rates or rotations per minute. This change can be made without stopping the handheld motor source. In some embodiments, a biological sample is spun at a rate of rotations per minute before subsequently being adjusted to spin at a different rate of rotations per minute. In some embodiments, a removed portion of the biological sample can comprise, for example, tissue fragments, a platelet poor plasma layer, a buffy layer, an erythrocyte layer, or any other biologic fluid. In some embodiments, steps (b)-(d) can be repeated 20 or more times (e.g., 1, 2, 3, 4, 5, 6, 7, 8, 9, 10, 11, 12, 13, 14, 15, 16, 17, 18, 19, 20, or more times).

Also provided are methods of using the devices described herein, for enrichment of a biologic sample. Enriching a biological sample can include (a) placing a biological sample within one or more containment devices and connecting them to a shaft, (b) attaching a handheld motor source to the shaft and activating the motor source to spin the shaft and the one or more containment devices, (c) allowing the biological sample to spin at one or more rate(s) of rotations per minute for a set period of time or times, (d) removing a portion of the biological sample, and (e) adding the removed portion of the biological sample to a second biological sample (e.g., a blood sample or tissue sample) and incubating the removed portion of the biological sample with the second biological sample (e.g., a blood sample or tissue sample), thereby producing an enriched second biological sample (e.g., an enriched blood sample). In some embodiments, incubation of the removed portion of the biological sample can be for about 1, 2, 3, 4, 5, 6, 7, 8, 9, 10, 11, 12, 13, 14, 15, 16, 17, 18, 19, 20 or more hours. In some embodiments, the biological sample can be passed through a filter. In some embodiments, a biological sample can be spun at one or more rates or rotations per minute. This change can be made without stopping the handheld motor source. In some embodiments, a biological sample is spun at a rate of rotations per minute before subsequently being adjusted to spin at a different rate of rotations per minute. In some embodiments, a removed portion of the biological sample can comprise, for example, tissue fragments, a platelet poor plasma layer, a buffy layer, an erythrocyte layer, or any other biologic fluid. In some embodiments, steps (b)-(d) can be repeated 20 or more times (e.g., 1, 2, 3, 4, 5, 6, 7, 8, 9, 10, 11, 12, 13, 14, 15, 16, 17, 18, 19, 20, or more times). In some embodiments, a removed portion of the biological sample can include, for example, tissue fragments, a platelet poor plasma layer, a buffy layer, an erythrocyte layer, or combinations thereof. The method of enriching a biological sample can also include using a device disclosed herein to fractionate the second biological sample (e.g., the enriched blood sample), thereby separating an enriched serum from the second biological sample (e.g., the enriched blood sample).

Also provided are methods of using the devices described herein for fractionation of a biologic sample. Methods can include separating a biologic sample in which component parts are disaggregated. Methods can include (a) placing a biological sample within one or more containment devices and connecting them to a shaft, (b) attaching a handheld motor source to the shaft and activating the motor source to spin the shaft and the one or more containment devices, (c) allowing the biological sample to spin at one or more rate(s) of rotations per minute for a set period of time or times, and (d) removing the biological sample or portion thereof from the one of more containment devices. In some embodiments, the biological sample can be passed through a filter. In some embodiments, a biological sample can be spun at one or more rates or rotations per minute. This change can be made without stopping the handheld motor source. In some embodiments, a biological sample is spun at a rate of rotations per minute before subsequently being adjusted to spin at a different rate of rotations per minute. In some embodiments, a removed portion of the biological sample can comprise, for example tissue fragments, a platelet poor plasma layer, a buffy layer, an erythrocyte layer, or any other biologic fluid. In some embodiments, steps (b)-(d) can be repeated 20 or more times (e.g., 1, 2, 3, 4, 5, 6, 7, 8, 9, 10, 11, 12, 13, 14, 15, 16, 17, 18, 19, 20, or more times). In some embodiments, one or more fractionated portions of a biological sample can be removed via an outlet port. In some embodiments, a whole blood sample can be fractionated into a platelet poor plasma layer, a buffy layer, and an erythrocyte layer.

The devices disclosed herein can be used to prepare a platelet rich plasma. The method can include placing a whole blood sample into one or more containment devices; attaching a handheld motor to a shaft, attaching one or more containment devices to a distal region of a shaft below the handheld motor; actuating the handheld motor to spin the one or more containment devices causing the whole blood sample to fractionate into a platelet poor plasma layer, a buffy layer, and an erythrocyte layer within the one or more containment devices; optionally removing at least a portion of the platelet poor plasma layer from the one or more containment devices; and actuating the handheld motor to spin the containment device causing any of the platelet poor plasma layer, the buffy layer, and the erythrocyte layer to fractionate into a platelet rich plasma layer and an erythrocyte layer. In some embodiments, one or more fractionated portions can be removed via an outlet port.

A containment device can be spun at a speed suitable to produce the desired end product. This will vary based on the fluid type, starting volume, and desired end product (type of cells and volume). Any suitable motor speed and time can be used. In an embodiment, a biological fluid or tissue such as whole blood, bone marrow, adipose tissue, or a combination thereof, can be spun at a rate of rotations per minute (RPM) sufficient to create a relative centrifugal force (RCF) that is equal to or less than 2665×g but still fractionates the fluid or tissue into, for example, a plasma layer, a buffy coat layer, and an erythrocyte layer (e.g., a hard spin). In some embodiments, a sample is spun with a “hard spin” at an RPM rate sufficient to produce an RCF of 1700×g. In an embodiment, a sample can be spun at an RPM rate sufficient to produce an RCF of about 1500×g, about 1550×g, about 1600×g, about 1650×g, about 1675×g, about 1725×g, about 1750×g, about 1775×g, about 1800×g, about 1825×g, about 1850×g, about 1875×g, about 1900×g, about 1925×g, about 1950×g, or about 1975×g. In an illustrative embodiment, a sample can be spun at a RCF of about 1500×g up to 2000×g, about 1550×g up to 2000×g, about 1600×g up to 2000×g, about 1650×g up to 2000×g, about 1675×g up to 2000×g, about 1700×g up to 2000×g, about 1725×g up to 2000×g, about 1750×g up to 2000×g, about 1775×g up to 2000×g, about 1800×g up to 2000×g, about 1825×g up to 2000×g, about 1850×g up to 2000×g, about 1875×g up to 2000×g, about 1900×g up to 2000×g, about 1925×g up to 2000×g, about 1950×g up to 2000×g, or about 1975×g up to 2000×g.

In an illustrative embodiment, a sample can be spun at an RPM rate sufficient to produce an RCF of about 1500×g to about 1900×g, about 1550×g to about 1900×g, about 1600×g to about 1900×g, about 1650×g to about 1900×g, about 1675×g to about 1900×g, about 1700×g to about 1900×g, about 1725×g to about 1900×g, about 1750×g to about 1900×g, about 1775×g to about 1900×g, about 1800×g to about 1900×g, about 1825×g to about 1900×g, about 1850×g to about 1900×g, or about 1875×g to about 1900×g (e.g., a hard spin).

In an illustrative embodiment, a sample can be spun at an RPM rate sufficient to produce an RCF of about 1500×g to about 1800×g, about 1550×g to about 1800×g, about 1600×g to about 1800×g, about 1650×g to about 1800×g, about 1675×g to about 1800×g, about 1700×g to about 1800×g, about 1725×g to about 1800×g, about 1750×g to about 1800×g, about 1775×g to about 1800×g, about 1650×g to about 1750×g, about 1675×g to about 1750×g, about 1700×g to about 1750×g, about 1675×g to about 1725×g, or about 1700×g to about 1725×g (e.g., a hard spin).

In an embodiment, a sample, such as a sample that has been subjected to a hard spin, or a sample not yet subjected to spinning, can be spun at an RPM rate sufficient to produce an RCF that is less than 400×g, which fractionates a blood sample into a plasma layer and an erythrocyte layer (e.g., a soft spin). In an illustrative embodiment, a plasma layer is a platelet rich plasma layer. In some embodiments, the sample is spun with a “soft spin” at 375×g. In an embodiment, a sample can be spun at an RPM rate sufficient to produce an RCF of about 30×g, about 35×g, about 40×g, about 45×g, about 50×g, about 55×g, about 60×g, about 70×g, about 75×g, about 80×g, about 90×g, about 100×g, about 110×g, about 120×g, about 125×g, about 150×g, about 175×g, or about 200×g.

In an illustrative embodiment, a sample can be spun at an RPM rate sufficient to produce an RCF of about 30×g to about 200×g, about 30×g to about 175×g, about 30×g to about 150×g, about 30×g to about 125×g, about 30×g to about 120×g, about 30×g to about 110×g, about 30×g to about 100×g, about 30×g to about 90×g, about 30×g to about 80×g, about 30×g to about 75×g, about 30×g to about 70×g, about 30×g to about 60×g, about 30×g to about 50×g, about 30×g to about 45×g, about 40×g to about 200×g, about 40×g to about 175×g, about 40×g to about 150×g, about 40×g to about 125×g, about 40×g to about 120×g, about 40×g to about 110×g, about 40×g to about 100×g, about 40×g to about 90×g, about 40×g to about 80×g, about 40×g to about 75×g, about 40×g to about 70×g, about 40×g to about 60×g, about 40×g to about 50×g, or about 40×g to about 45×g (e.g., a soft spin).

In an embodiment, a first spin (e.g., a hard spin) can be about 3, about 4, about 5, about 6, about 7, about 8, about 9, about 10, about 11, about 12, about 13, about 14, about 15, about 20, about 25, or about 30 minutes. In an embodiment, a second spin (e.g., a soft spin) can be about 3, about 4, about 5, about 6, about 7, about 8, about 9, about 10, about 11, about 12, about 13, about 14, about 15, about 20, about 25, or about 30 minutes.

In an illustrative embodiment, at least a portion of a plasma layer can be removed after a first spin (e.g., hard spin) and before a second spin (e.g. a soft spin). In an embodiment, at least half, at least 75%, at least 80%, at least 85%, at least 90%, at least 95%, at least 98%, at least 99%, or 100% of the plasma layer is removed. The removed plasma layer can be saved for other purposes, such as diluting a final PRP. In an embodiment after a first hard spin, part of the platelet poor plasma fraction (i.e., that closest to the buffy coat layer), the buffy coat layer, and part of the erythrocyte layer (i.e., that closest to the buffy coat layer) is collected. This can be used a therapeutic fluid. Alternatively, this sample can be spun again such that a top platelet rich plasma fraction and a bottom erythrocyte fraction is obtained. The top platelet rich plasma fraction can be collected as well. “Part” of a fraction can be about 5, 10, 20, 30, 40, 50% or more of fraction or about 50, 40, 30, 20, 10, 5% or less of a fraction. In an embodiment, after a first hard spin, the buffy coat fraction is collected.

In some embodiments, only a single soft spin is used. Where the sample is a blood sample, a soft spin can result in two layers: a PRP layer and an erythrocyte layer. In this embodiment, a leukocyte-reduced PRP (the top fraction) is produced as the therapeutic fluid.

Methods of Treatment

The system described herein can be used to extract, separate, enrich, purify, or concentrate a biological sample. Therapeutic fluids produced by compositions and methods described herein can be employed for treatment of human joints, for example, a shoulder joint, a hip joint, an elbow joint, or a knee joint. The therapeutic fluids can be employed for treatment of various cartilage, ligament, or tendon damage or diseases such as, for example: Chondromalacia I′-III°; large and small joints of upper and lower extremities; small vertebral joints; traumatologic cartilage damage; post-operative situations e.g., flake fracture refixation, microfractures and/or cartilage transplantation (autologous cartilage transplantation or osteoarticular transfer device); and tendinosis and ligamentosis.

Therapeutic fluids can also be employed in neurosurgery applications, such as, for example: radiculitis and radiculopathy of the cervical and lumbar spine; syndrome of the vertebral column facets; and other spinal applications, e.g., degeneration of spinal disk and erosive osteochondrosis. Therapeutic fluids can also be employed in other surgical applications, such as, for example: calcaneus surgery, hammertoe correction, ACL repair, MCL repair, shoulder surgeries, Achilles tendon surgeries, arthroplasty, osteotomy, hip labral reconstruction, rotator cuff repair, bunionectomy, cheilectomy, or any other suitable surgery.

Therapeutic fluids can be clotted before administration using techniques known in the art. Therapeutic fluids can also be applied via a patch, an autograft, or an allograft.

In some embodiments, the system described herein can be used to prepare enriched serum. Enriched serum prepared using the system described herein can be used to treat inflammation, inflammatory joint, or rheumatoid arthritis in a subject, and to prevent inflammation of a joint following an arthroscopic surgery in a subject.

A method of treating inflammation, inflammatory joint, or rheumatoid arthritis in a subject is provided.

A method of preventing inflammation of a joint following an arthroscopic surgery in a subject is also provided.

As used herein, the term “inflammation” can refer to a process induced by white blood cells to protect from infection. Some diseases, such as arthritis, can trigger an inflammation response even in the absence of an infection-causing pathogen. In such cases, e.g., when the subject has an autoimmune disease, the immune system acts as if regular tissues were infected which can cause tissue damage. Inflammation can be acute (short-lived, e.g., goes away within hours or days) or chronic (long-lasting, e.g., can last months or years, even after the first trigger is gone). Conditions linked to chronic inflammation can include cancer, heart disease, diabetes, asthma, Alzheimer's disease, and arthritis, such as rheumatoid arthritis, psoriatic arthritis, or gouty arthritis. Other painful conditions of the joints and musculoskeletal system that can be related to inflammation include osteoarthritis, fibromyalgia, muscular low back pain, and muscular neck pain.

“Inflammatory joint” or “arthritis” can be used to describe conditions characterized by pain, swelling, tenderness and warmth in the joints, as well as morning stiffness that lasts for more than an hour. The most common forms are rheumatoid arthritis (RA), psoriatic arthritis (PsA), systemic lupus erythematosus (SLE, lupus), gout and ankylosing spondylitis (AS). In these diseases, the immune system doesn't work properly and releases inflammatory chemicals. The resulting inflammation attacks joint tissues and can cause joint swelling, increased joint fluid, cartilage and bone damage, and muscle loss. Nerves in the joints are also activated, causing pain. The inflammatory chemicals can directly activate other nerves of the body and lead to pain as well.

The term “subject” as used herein refers to any individual or patient to which the subject methods are performed. Generally, the subject is human, although as will be appreciated by those in the art, the subject can be an animal. Thus, other animals, including vertebrate such as rodents (including mice, rats, hamsters and guinea pigs), cats, dogs, rabbits, farm animals including cows, horses, goats, sheep, pigs, chickens, etc., and primates (including monkeys, chimpanzees, orangutans and gorillas) are included within the definition of subject.

The term “treatment” is used interchangeably herein with the term “therapeutic method” and refers to both 1) therapeutic treatments or measures that cure, slow down, lessen symptoms of, and/or halt progression of a diagnosed pathologic conditions or disorder, and 2) and prophylactic/preventative measures. Those in need of treatment can include individuals already having a particular medical disorder as well as those who can ultimately acquire the disorder (i.e., those needing preventive measures).

The terms “administration of” and or “administering” should be understood to mean providing a pharmaceutical composition in a therapeutically effective amount to the subject in need of treatment. Accordingly, administration routes of enriched biological sample described herein can include but are not limited to intracutaneous, subcutaneous, intracapsular, intraarticulare, subcapsular, and intraspinal administrations. In an embodiment, the enriched biological sample can be injected at an inflammation site, inflammatory joint, or rheumatoid arthritis site.

In some embodiments, administration can be in combination with one or more additional therapeutic agents. The phrases “combination therapy”, “combined with” and the like refer to the use of more than one medication or treatment simultaneously to increase the response. The composition of the present invention can for example be used in combination with other drugs or treatment in use to treat inflammation. Specifically, the administration of the enriched biological sample to a subject can be in combination with an anti-inflammatory molecule. Such therapies can be administered prior to, simultaneously with, or following administration of the composition of the present invention.

The phrase “anti-inflammatory molecule” refers to any molecule capable of inhibiting or reducing an inflammatory response. Examples of anti-inflammatory molecules include, but are not limited to, IL-1 receptor antagonist, IL-4, IL-6, IL-10, IL-11, IL-13, nonsteroidal anti-inflammatory drugs (NSAIDs, such as aspirin, ibuprofen, or naproxen), corticosteroids, calcineurin inhibitors, TGF-β, vitamin D and retinoic acid.

Corticosteroids are a class of steroid hormones that are produced in the adrenal cortex of vertebrates, as well as the synthetic analogues of these hormones. Two main classes of corticosteroids, glucocorticoids and mineralocorticoids, are involved in a wide range of physiologic processes, including stress response, immune response, and regulation of inflammation, carbohydrate metabolism, protein catabolism, blood electrolyte levels, and behavior. Some common naturally occurring steroid hormones are cortisol, corticosterone, and cortisone. Other examples of corticosteroids include prednisone, prednisolone, dexamethasone, budesonide, beclomethasone dipropionate, triamcinolone acetonide, fluticasone propionate, fluticasone furoate, flunisolide, methylprendisone and hydrocortisone.

Calcineurin inhibitors suppress the immune system by preventing interleukin-2 (IL-2) production in T cells. Examples of calcineurin inhibitors include cyclosporine and tacrolimus. Cyclosporine and tacrolimus bind to the intracellular immunophilins cyclophilin and FKBP-12, respectively. When bound, both molecules inhibit the phosphatase action of calcineurin, which is required for the movement of nuclear factors in activated T cells to the chromosomes where subsequent cytokine synthesis occurs. Decreased secretion of IL-2 prevents proliferation of the inflammatory response via B cells and T cells. The attenuated inflammatory response greatly reduces the overall function of the immune system.

The compositions and methods are more particularly described below, and the Examples set forth herein are intended as illustrative only, as numerous modifications and variations therein will be apparent to those skilled in the art. As used in the description herein and throughout the claims that follow, the meaning of “a”, “an”, and “the” includes plural reference unless the context clearly dictates otherwise. The term “about” in association with a numerical value means that the value varies up or down by 5%. For example, for a value of about 100, means 95 to 105 (or any value between 95 and 105).

The terms used in the specification generally have their ordinary meanings in the art, within the context of the compositions and methods described herein, and in the specific context where each term is used.

All patents, patent applications, and other scientific or technical writings referred to anywhere herein are incorporated by reference herein in their entirety. The embodiments illustratively described herein suitably can be practiced in the absence of any element or elements, limitation or limitations that are specifically or not specifically disclosed herein. Thus, for example, in each instance herein any of the terms “comprising”, “consisting essentially of”, and “consisting of” can be replaced with either of the other two terms, while retaining their ordinary meanings. The terms and expressions which have been employed are used as terms of description and not of limitation, and there is no intention that in the use of such terms and expressions of excluding any equivalents of the features shown and described or portions thereof, but it is recognized that various modifications are possible within the scope of the embodiments claimed. Thus, it should be understood that although the present compositions and methods have been specifically disclosed by embodiments, optional features, modification and variation of the concepts herein disclosed can be resorted to by those skilled in the art, and that such modifications and variations are considered to be within the scope of these embodiments as defined by the description and the appended claims.

Any single term, single element, single phrase, group of terms, group of phrases, or group of elements described herein can be each be specifically excluded from the claims.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the aspects herein. It will be understood that any elements or steps that are included in the description herein can be excluded from the claimed compositions or methods

In addition, where features or aspects of the embodiments are described in terms of Markush groups or other grouping of alternatives, those skilled in the art will recognize that the embodiments are also thereby described in terms of any individual member or subgroup of members of the Markush group or other group.

The following are provided for exemplification purposes only and are not intended to limit the scope of the invention described in broad terms above.

Although the different non-limiting embodiments are illustrated as having specific components, the embodiments of this disclosure are not limited to those particular combinations. It is possible to use some of the components or features from any of the non-limiting embodiments in combination with features or components from any of the other non-limiting embodiments. Indeed, the embodiments, examples and alternatives of the preceding paragraphs, the claims, or the following description and drawings, including any of their various aspects or respective individual features, can be practiced independently or in any combination. Features described in connection with one embodiment are applicable to all embodiments, unless such features are incompatible.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A system for biological sample processing comprising:
one or more containment devices for a biological sample connected to a shaft; and
a handheld motor source connected to the shaft and configured to modulate spinning the one or more containment devices along an axis of the one or more containment devices.

2. The system of claim 1, wherein the one or more containment devices comprise:
two or more tubular vessels counter disposed within buckets, wherein the two or more tubular vessels are configured to freely rotate from an upright position to a horizontal position or any angle between the upright position and the horizontal position.

3. The system of claim 1, wherein the one or more containment devices comprise one or more inlet or outlet ports.

4. The system of claim 1, wherein the one or more containment devices comprise:
(a) a disc having a top plate, a bottom plate, and an outside wall, wherein:
(i) the top plate, bottom plate, and outside wall all have an inner surface and an outer surface;
(ii) the outside wall connects the top and bottom plates; and
(iii) the inner surface of the top plate and the inner surface of the bottom plate face one other; and
(b) a compartment enclosed by the inner surfaces of the top plate, bottom plate, and outside wall.

5. The system of claim 4, wherein the one or more containment devices further comprise at least one filter element or membrane comprising an inside edge and an outside edge, wherein the at least one filter element or membrane is located inside the compartment.

6. The system of claim 1, wherein a distal portion of the shaft and the one or more containment devices are housed within an enclosure.

7. The system of claim 1, wherein the system is handheld and can be operated under the full control of a user.

8. The system of claim 1, wherein the handheld motor source can spin the one or more containment devices at a rate of rotations per minute sufficient produce g-forces needed for separating biological samples.

9. The system of claim 1, wherein the handheld motor source is configured to adjust a first g-force to a second g-force within about 0.5, 1, 2, 3, 4, 5, 6, 7, 8, 9, 10, 11, 12, 13, 14, 15, 16, 17, 18, 19, 20, 30, 40, 50, 60, or 70 seconds without causing rotations per minute of the motor source to reach zero.

10. The system of claim 1, wherein the handheld motor source comprises a surgical drill, a dental handpiece, a surgical shaver, or a handheld device capable of reaching a rate of rotations per minute sufficient for concentration, purification, or fractionation of a biologic sample.

11. The system of claim 1, wherein the one or more containment devices are disposable.

12. The system of claim 1, wherein a fraction of the biological sample can be extracted from the one or more containment devices using one or more outlet ports.

13. The system of claim 1, further comprising a base configured to accept a distal end of the shaft for stabilization.

14. The system of claim 1, wherein the containment device comprises a variable volume separation chamber and a disc shaped bottom support plate.

15. The system of claim 1, wherein the containment device comprises a variable volume separation chamber, a disc shaped top support plate, and a disc shaped bottom support plate.

16. The system of claim 1, wherein the containment device is removable from the shaft and the handheld motor source is removable from the shaft.

17. A method of processing a biological sample, the method comprising:
placing a biological sample within one or more containment devices of the system of claim 1;
activating the handheld motor source to spin the shaft and the one or more containment devices;
allowing the biological sample to spin at one or more rate(s) of rotations per minute for a set period of time; and
obtaining a processed biological sample.

18. The method of claim 17, wherein the biological sample is spun at a first rate of rotations per minute and then at a second rate of rotations per minute.

19. The method of claim 17, wherein the biological sample is spun at a first rate of rotations per minute and then at a second rate of rotations per minute without stopping the motor source.

20. The method of claim 17, wherein the method of processing can further comprise concentrating the biological sample, purifying the biological sample, fractionating the biological sample, extracting the biological sample, filtering the biological sample, enriching the biological sample, or combinations thereof.

21. The method of claim 17, wherein a distal end of the shaft is placed in a base to stabilize the system.

22. The method of claim 17, wherein at least a distal portion of the shaft and the containment device are present within an enclosure.

23. A method of preparing platelet rich plasma using the system of claim 1, the method comprising:
placing a whole blood sample into one or more containment devices of the system of claim 1;
attaching a handheld motor to a proximal region of a shaft;
attaching one or more containment devices to a distal region of a shaft;
actuating the handheld motor to spin the one or more containment devices causing the whole blood sample to fractionate into a platelet poor plasma layer, a buffy layer, and an erythrocyte layer within the one or more containment devices;
removing at least a portion of the platelet poor plasma layer from the one or more containment devices; and
actuating the handheld motor to spin the containment device causing any of the platelet poor plasma layer, the buffy layer, and the erythrocyte layer to fractionate into a platelet rich plasma layer and an erythrocyte layer.

24. A method for purifying a biological sample using the system of claim 1, the method comprising:
a) placing a biological sample within one or more containment devices of the system of claim 1;
b) activating the handheld motor source to spin the shaft and the one or more containment devices;
c) allowing the biological sample to spin at one or more rate(s) of rotations per minute for a set period of time; and
d) removing a portion of the biological sample.

25. The method of claim 24, wherein the biological sample is spun at a first rate of rotations per minute and then at a second rate of rotations per minute.

26. The method of claim 24, wherein the biological sample is spun at a first rate of rotations per minute and then at a second rate of rotations per minute without stopping the motor source.

27. The method of claim 24, wherein the method further comprises repeating steps b)-d) 1, 2, 3, 4, 5, 6, 7, 8, 9, or 10 times.

28. The method of claim 24, further comprising discarding the removed portion of the biological sample and/or increasing one or more components of the biological sample in the sample, thereby concentrating the biological sample.

29. The method of claim 24, further comprising adding the removed portion of the biological sample to a blood or tissue sample and incubating the removed portion of the biological sample with the blood or tissue sample, thereby producing an enriched blood sample.

30. The method of claim 24, wherein a removed portion of the biological sample comprise tissue fragments, a platelet poor plasma layer, a buffy layer, an erythrocyte layer, or combinations thereof.

31. The method of claim 30, wherein the removed portion of the biological sample is incubated for about 4 hours or more.
